(19) United States
(12) Patent Application Publication
(10) Pub. No.: US 2014/0166558 A1
(43) Pub. Date: Jun. 19, 2014

(54) NITROGEN-REDUCING WASTEWATER TREATMENT SYSTEM

(71) Applicant: A.K. Industries, Inc., Plymouth, IN (US)

(72) Inventors: Stephen Sabo, South Bend, IN (US); Steven Davis, Plymouth, IN (US); James Conley, Plymouth, IN (US)

(73) Assignee: A.K. Industries, Inc., Plymouth, IN (US)

(21) Appl. No.: 14/134,860

(22) Filed: Dec. 19, 2013

Related U.S. Application Data
(60) Provisional application No. 61/739,130, filed on Dec. 19, 2012.

(51) Int. Cl. C02F 3/30

(52) U.S. Cl. CPC C02F 3/30
USPC 210/142; 210/195.1

(57) ABSTRACT

A wastewater treatment system is provided having a pretreatment tank which receives wastewater from a wastewater source, and an aeration tank which is in fluid communication with the pretreatment tank. A recirculation pump is carried in the aeration tank and returns wastewater from the aeration tank to the pretreatment tank. The recirculation pump returns the wastewater according to a recirculation ratio R:I where R is the volumetric flow rate of wastewater through the recirculation pump and I is average volumetric flow rate of wastewater entering the pretreatment tank. A control panel cycles the recirculation pump on and off according to the recirculation ratio.

### CROSS REFERENCE TO RELATED APPLICATIONS

This application claims the benefit of U.S. Provisional Application No. 61/739,130, filed Dec. 19, 2012, the disclosure of which is hereby incorporated by reference.

### BACKGROUND OF THE INVENTION

Home wastewater treatment is an economical option for buildings which are located in areas without access to a city sewage system, or where the costs of hooking the building into a municipal sewage system are prohibitive. Home wastewater treatment systems perform similar functions as a sewage plant, but on a much smaller scale. These systems are typically located underground. After the wastewater has been treated it is typically discharged as waste on the property. It is essential that the wastewater is processed sufficiently so that the discharged water does not pose a threat to the environment.

In some geographical regions, wastewater discharged from a home wastewater treatment system—the wastewater effluent—must contain reduced nitrogen levels. When wastewater effluent contains excess amounts of nitrogen-based compounds, and when such wastewater effluent enters waterways, eutrophication, or hypertrophication can result. Eutrophication is the response of an ecosystem to excess artificial natural or artificial substances. One example of eutrophication is the increase of phytoplankton in a body of water, such increase can result in a “bloom” or bright green coloring of the water. Not only does eutrophication discolor the water, but it also disrupts the ecosystem, and can deplete the oxygen levels in the water, which in turn can cause natural species, such as fish, to reduce in numbers or die off.

There are several types of nitrogen which may be present in wastewater and which may need to be reduced, such as ammonia, nitrate, nitrite and organically-bound nitrogen. Total Kjeldahl Nitrogen (TKN) is a test method that measures the combination of organically-bound nitrogen and ammonia. Total Nitrogen (TN) is the sum of the TKN and nitrate and nitrite. To prevent eutrophication and other problems related to excess nitrogen, it is desired that the TN in the wastewater effluent is reduced. It is desired that the TN in the wastewater effluent be reduced by a minimum of 50% relative the TN of the wastewater influent.

One way to reduce nitrogen is through the use of a combination of aerobic and anaerobic bacteria. One suitable pathway of bacteria-aided nitrogen reduction is described as follows. The bacteria reduce ammonia to nitrite, and those or other bacteria reduce nitrite to nitrate, finally the nitrate is denitrified into molecular nitrogen, N₂ by bacteria. The molecular nitrogen bubbles out of the system, which results in an overall reduction in the nitrogen content in the wastewater. The final step of denitrification generally requires anaerobic conditions, while the other steps typically require aerobic conditions. As such, the wastewater treatment system must be designed to oscillate between aerobic and anaerobic conditions such that all phases of the nitrogen-reduction process may be achieved.

At the same time, the wastewater treatment system must be suitable for performing its primary function, which is to process the waste found in the wastewater. Typically, such waste is processed by bacteria which digests the waste into byproducts which are suitable for being discharged into the environment.

As such, an improved home wastewater treatment system is needed which is suitable to both process the waste in the wastewater and to reduce the TN in the wastewater.

### SUMMARY OF THE INVENTION

The present disclosure describes a wastewater treatment system which reduces both the waste content and the nitrogen levels in the wastewater effluent. The wastewater treatment system described herein includes a pretreatment tank and an aeration tank. The pretreatment tank provides an anaerobic environment which allows solids to settle out of the wastewater and encourages the growth of anaerobic bacteria which digest the waste in the wastewater. The aeration tank includes diffusers which add air to the wastewater therein, which air oxygenates the wastewater, thereby encouraging the growth of aerobic bacteria which aid in further digesting the waste contained in the wastewater. A recirculation pump is included in the aeration tank and pumps a portion of the wastewater from the aeration tank back to the pretreatment tank. As such, a portion of the wastewater in the aeration tank is returned to the pretreatment tank. The recirculation pump is activated by a controller such that the recirculation pump cycles on and off according to the flow rate of wastewater into the wastewater treatment system. The result is an environment that favors both wastewater treatment and nitrogen reduction.

### BRIEF DESCRIPTION OF THE DRAWINGS

A preferred embodiment of this invention has been chosen wherein:

FIG. 1 is side view of the wastewater treatment system showing internal components in dotted lines and an optional pump tank shown in dotted lines; and

FIG. 2 is a top view of the wastewater treatment system of FIG. 1 showing internal components in dotted lines and an optional pump tank shown in dotted lines.

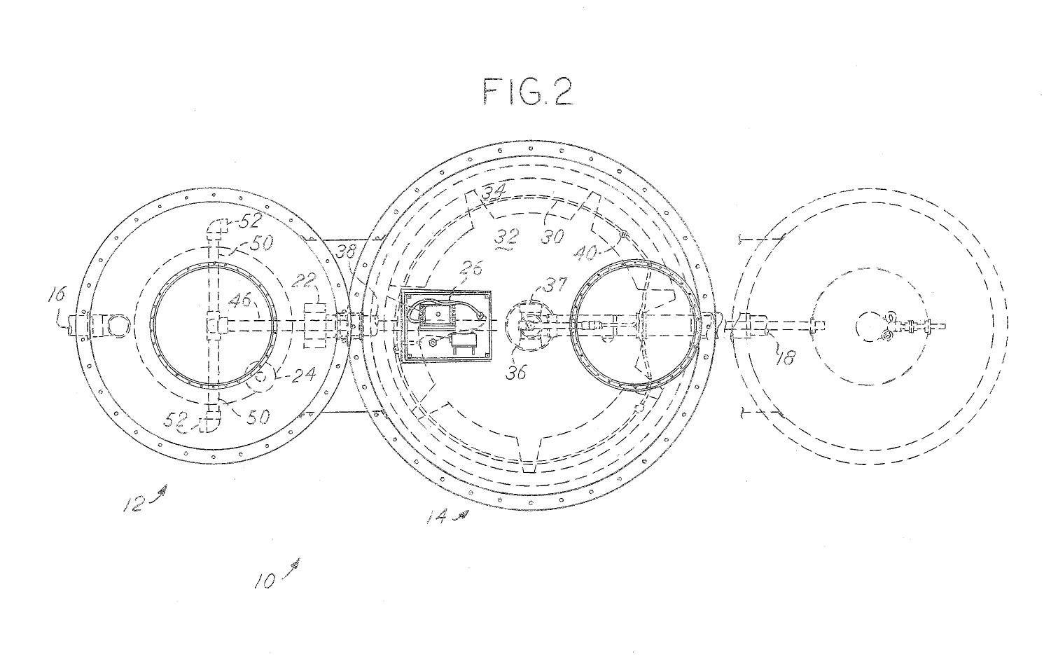

### DESCRIPTION OF THE PREFERRED EMBODIMENT

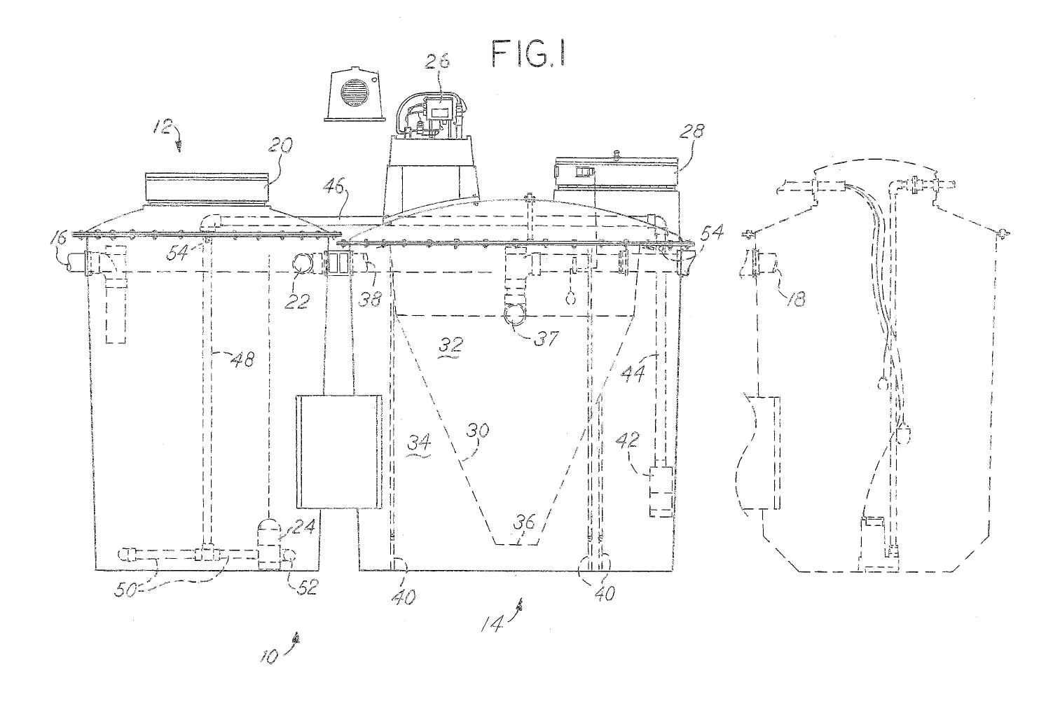

Referring now to FIG. 1, the present disclosure describes a wastewater treatment system 10 which includes a pretreatment tank 12 and an aeration tank 14. The pretreatment tank 12 and the aeration tank 14 are liquid holding vessels which are in fluid communication with one another and serve the purpose of treating wastewater. Pretreatment tank 12 includes an inlet 16 which accepts wastewater influent into the wastewater treatment system 10. The inlet 16 is in fluid communication with a wastewater source, such as a residential home, though the application of the wastewater treatment system 10 is not limited to residential uses. The aeration tank 14 includes an outlet 18 which discharges wastewater effluent out of the wastewater treatment system 10. The wastewater effluent discharged from the outlet 18 is typically dispersed into the ground through a drip field, though other discharge pathways are contemplated, and this description is not limited thereto. Further, in some instances a pump tank accepts the effluent from the outlet 18, which pump tank doses the flow rate of the effluent, but again, the present description is not limited thereto.

Referring now to the pretreatment tank 12, the pretreatment tank 12 is a tank which preferably includes a riser 20, such that the pretreatment tank 12 may be buried underground with the riser 20 serving as an access portal for the tank. The pretreatment tank 12 includes a pretreatment tank outlet 22 which is preferably positioned at the same vertical height as the inlet 16, such that gravity moves the wastewater out of the outlet 22. A mixer pump 24 is positioned within the pretreatment tank 12. The mixer pump 24 is connected to a control panel 26 which activates and deactivates the mixer pump 24 according to defined parameters, such as the flow rate of the wastewater into the pretreatment tank, a defined schedule, or other parameters. Alternatively, the mixer pump 24 operates continuously. The mixer pump 24 serves to mix or circulate wastewater within the pretreatment tank 12. The mixer pump 24 may be operated throughout the life of wastewater treatment system 10, but is particularly important during the start-up phase of the treatment system. The mixer pump 24 helps to ensure good mixing in the pretreatment tank 12. Such mixing is especially important during the start-up phase of the wastewater treatment system 10. During such start-up phase, to achieve good results in reducing TN, it is important that a sufficiently large colony of bacteria is formed in the pretreatment tank 12, and mixing helps to encourage such bacteria growth. Once the bacteria colony has become established (which can take 4-8 weeks after startup), the mixer pump 24 can be deactivated and/or removed from the pretreatment tank 12.

Referring now to the aeration tank 14, the aeration tank 14 is a tank, suitable for housing a fluid, which preferably includes a riser 28, such that the aeration tank 14 may be buried underground with the riser 28 serving as an access portal for the tank. The aeration tank 14 includes a cone 30 which partitions the tank into a pair of chambers: an inner chamber 32 defined as the area within the cone 30 and an outer chamber 34 defined as the area outside the cone 30. The cone 30 is preferably frusto-conical, having an opening 36 which allows fluid communication between the inner chamber 32 and the outer chamber 34. An aeration tank outlet 37 is positioned proximate the upper end of the cone 30, which outlet is in fluid communication with the outlet 18 of the wastewater treatment system 10. The aeration tank 14 includes an aeration tank inlet 38 which is in fluid communication with the pretreatment tank outlet 22. The aeration tank inlet 38 is positioned near the upper end of the outer chamber 34. In this way, the aeration tank 14 includes a fluid pathway that begins at the aeration tank inlet 38, passes through the outer chamber 34, passes up through the opening 36 of the cone 30 into the inner chamber 32, and then out through the aeration tank outlet 37; such fluid pathway is gravity fed, whereby the aeration tank inlet 38 is at the same vertical height as the outlet 18.

One or more diffusers 40 are present in aeration tank 14, preferably in the outer chamber 34 near the floor of the aeration tank 14. The diffusers 40 emit air into aeration tank 14, at least a portion of such air will contain oxygen, thereby oxygenating the wastewater. The diffusers 40 are connected by air supply lines to an air source. The air supply lines are preferably connected to an air pump which forces the air through the diffusers 40. Such air pump is electrically connected to the control panel 26. The control panel 26 cycles the air pump on and off to control the rate at which air is emitted from the diffusers 40. By oxygenating the wastewater, an aerobic condition is favored in the aeration tank 14, which encourages the growth of aerobic bacteria. The aerobic bacteria aids in digesting the waste in the wastewater in the aeration tank 14. Aerobic bacteria also aids in the nitrification of the wastewater in the aeration tank 14.

A recirculation pump 42 is positioned in the aeration tank 14, preferably in the outer chamber 34. The recirculation pump 42 is submersible. The recirculation pump 42 draws in wastewater from the aeration tank 14 and pumps the wastewater through a recirculation pipe to the pretreatment tank 12. The recirculation pipe is preferably formed from a first recirculation pipe 44, a connecting pipe 46 and a second recirculation pipe 48, which together form a pathway by which wastewater is pumped from the aeration tank 14 to the pretreatment tank 12. In the preferred embodiment, the first recirculation pipe 44 is joined to a first end of the connecting pipe 46 by a connector, such as an elbow. Similarly, it is preferred that a second end of the connecting pipe 46 is joined to the second recirculation pipe 48 by a connector, such as an elbow. The first recirculation pipe 44 and the second recirculation pipe 48 are oriented generally vertically—or roughly parallel with the sidewalls of the pretreatment and aeration tanks 12, 14. The connecting pipe 46 is oriented generally horizontally—or roughly perpendicular to the first and second recirculation pipes 44, 48. Together, the first recirculation pipe 44, the connecting pipe 46 and the second recirculation pipe 48 are U-shaped with the connecting pipe 46 positioned at or near the upper end of both the pretreatment tank 12 and the aeration tank 14, and having first and second recirculation pipes 44, 46 extending downwardly from the ends of the connecting pipe 46 and into the wastewater in the respective tanks.

The second recirculation pipe 48 terminates at the lower end thereof to one or more extension arms 50, preferably at least two extension arms extending parallel with the floor of the pretreatment tank 12 and spaced equiangularly about the second recirculation pipe 48. Each extension arm 50 terminates in a recirculation outlet 52 which is aimed perpendicularly to the length of the arm 50, or roughly tangential to the nearest portion of the circumference of pretreatment tank 12. The extension arms 50 are preferably proximate the floor of the pretreatment tank 12. In this way, the recirculation outlet 52 serves to stir and mix the wastewater in the pretreatment tank 12 as wastewater is discharged from the recirculation outlet 52.

The recirculation pump 42 is in electrical communication with the control panel 26, such that the control panel 26 cycles the recirculation pump 42 on and off according to defined parameters. Preferably, the control panel 26 will be programmed to recirculate wastewater according to a recirculation ratio of between two to one and six to one—two to six volumetric units of wastewater will be recirculated from the aeration tank 14 to the pretreatment tank 12 for every volumetric unit of wastewater which enters the pretreatment tank 12. The particular recirculation ratio selected for a given wastewater treatment system 10 depends on the average volumetric flow rate of wastewater influent, the volumetric capacity of the wastewater treatment system 10, and the nitrogen content of the influent. A skilled technician will select a recirculation ratio according to these and other parameters and program the control panel 26 accordingly to achieve the desired TN in the effluent. It may be necessary for a technician to adjust the programming in the control panel 26 from time to time to keep the TN in the effluent at the desired value.

Typically, wastewater will not enter the wastewater treatment system 10 at a constant flowrate, but will enter intermittently according to the water usage of the adjoining structure, such as when a toilet or shower is used. The recirculation of wastewater from the aeration tank 14 to the pretreatment tank 12 results in the reduction of the nitrogen-based compounds that have a tendency to lead to eutrophication, such that the present wastewater treatment system 10 is ideal for locales where eutrophication is a concern. Absent recirculation as described herein, the output from the wastewater treatment system 10 would be nitrogen-rich and would potentially lead to eutrophication. TN reduction is achieved, at least in part, by cycling the wastewater from the aeration tank 14 back to the pretreatment tank 12, thereby having a given volume of wastewater oscillating between aerobic and anaerobic conditions.

The connecting pipe 46 is preferably positioned above the level of the wastewater in the pretreatment tank 12 and the aeration tank 14. As such, the connecting pipe 46 will be at least partially located in the ground in which the wastewater treatment system 10 is buried, and will be a relatively short distance from ground level. As such, the connecting pipe 46 may be positioned above the frost line, such that during cold spells, any fluid remaining in the connecting pipe 46 may have a tendency to freeze. To combat freezing, a weep hole 54 is positioned proximate each end of the connecting pipe 46, which weep holes 54 allow wastewater to drain out of the connecting pipe 46 into the respective tank 12, 14. In this way, between recirculation cycles, connecting pipe 46 will be drained of wastewater, thereby chances of freezing will be diminished.

Recirculation of wastewater from the aeration tank 14 to the pretreatment tank 12 is controlled by the control panel 26, and can be triggered in a number of ways. In one instance, when wastewater treatment system 10 is first installed, expected wastewater output can be approximated based on the size of the attached home and the estimated number of residents. The recirculation rate is pre-programed in the control panel 26 based on the expected daily wastewater output such that the recirculation pump 42 is programmed to cycle on and off to achieve a desired recirculate rate. In another instance, a flow meter is positioned at the inlet 16 which measures the volumetric flow rate of wastewater entering wastewater treatment system 10 which measurement is used to achieve a desired recirculate rate. The control panel 26 cycles the recirculation pump 42 on and off to bring the recirculation rate to a desired recirculation ratio. The recirculation ratio is defined as the ratio of R to I, where R is defined as recirculation rate which is the volumetric flow rate of wastewater recirculated from the aeration tank 14 to the pretreatment tank 12 and I is defined as the inflow rate which is the volumetric flow rate of wastewater entering the pretreatment tank 12 through the inlet 16. The recirculation ratio varies according to several variables, including tank size and volumetric flow rate of wastewater influent into the pretreatment tank. The preferred recirculation ratio, R:I is in the range of 2:1 and 6:1, in other words, the volumetric flow rate of wastewater recirculated from the aeration tank 14 to the pretreatment tank 12 is preferably two to six times the volumetric flow rate of wastewater into pretreatment tank 12. R and I are typically calculated as daily averages since the actual flow rate at any given moment is dependent on the specific water use at such moment in the attached structure, but the average flow rate into wastewater treatment system 10 on any given day can be estimated based on the occupancy of the attached building and other factors. Other control schemes which accomplish the desired recirculation ratio as are known in the art may be substituted.

As such, the recirculation rate R of the recirculation pump 42 is volume-dependent, and therefore must be customized according to the parameters, such as flow rate of the influent, tank size, etc., of a given system.

The design of the wastewater treatment system 10 results in the wastewater recirculating between the anaerobic conditions of the pretreatment tank 12 and the aerobic conditions of the aeration tank 14. Such recirculation allows both the aerobic and the anaerobic bacteria to digest the waste present in the wastewater. Such recirculation also allows both the aerobic and the anaerobic bacteria to complete the nitrification and the denitrification steps which reduce the TN of the effluent wastewater.

As illustrated in FIG. 1, the inlets and outlets 16, 22, 38 and 18 are all generally in a common plane. In this configuration, wastewater moves through wastewater treatment system 10 generally from left to right by the flow of gravity. The recirculation pump 42 moves the wastewater from the aeration tank 14 upstream to the pretreatment tank 12.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A wastewater treatment system comprising:
a pretreatment tank having an inlet and an outlet, said inlet receiving wastewater influent from a wastewater source, said pretreatment tank having anaerobic conditions;
an aeration tank having aerobic conditions, said aeration tank having an inlet and an outlet, said inlet of said aeration tank in fluid communication with said outlet of said pretreatment tank;
a recirculation pump is carried in said aeration tank;
a recirculation pipe is in fluid communication with said recirculation pump, said recirculation pump moves wastewater from said aeration tank to said pretreatment tank, said recirculation pump moves said wastewater according to a defined recirculation ratio.

2. The wastewater treatment system of claim 1, wherein said recirculation ratio is defined as R:I where R is defined as the average volumetric flow rate of wastewater moved from said aeration tank to said pretreatment tank and I is defined as the average volumetric flow rate of wastewater influent entering said pretreatment tank through said inlet.

3. The wastewater treatment system of claim 2, wherein R is 2 to 6 times greater than I.

4. The wastewater treatment system of claim 1, and an extension arm extends from said recirculation pipe.

5. The wastewater treatment system of claim 4, and said pretreatment tank having a floor, said extension arm oriented generally parallel with said floor.

6. The wastewater treatment system of claim 5, and said extension arm terminating in a recirculation outlet which is oriented generally perpendicular to said extension arm.

7. The wastewater treatment system of claim 6, and a weep hole formed in said recirculation pipe.

8. The wastewater treatment system of claim 7, wherein said inlet and said outlet of said pretreatment tank are oriented in a common plane, said weep hole is spaced vertically above said common plane.

9. The wastewater treatment system of claim 1, and a control panel in electrical communication with said recirculation pump for cycling said recirculation pump on and off to achieve said recirculation ratio.
